(19) United States
(12) Patent Application Publication
(10) Pub. No.: US 2026/0341212 A1
(43) Pub. Date: Oct. 29, 2026

(54) DEVICE

(71) Applicant: CANON KABUSHIKI KAISHA, Tokyo (JP)

(72) Inventor: TAKASHI MUTO, Kanagawa (JP)

(21) Appl. No.: 19/653,517

(22) Filed: Apr. 21, 2026

(30) Foreign Application Priority Data
Apr. 23, 2025 (JP) 2025-071447

(51) Int. Cl. G09G 3/3233

(52) U.S. Cl. CPC G09G 3/3233; G09G 2300/0426; G09G 2310/08; G09G 2320/0233; G09G 2320/045; G09G 2380/02; G09G 2380/10

(57) ABSTRACT

A device includes a pixel array in which a plurality of pixels each including a light-emitting element and a driving circuit is arranged in matrix form, a first signal line connected to pixels arranged in a first column of the pixel array, a second signal line connected to pixels arranged in a second column, an output circuit connected to a first node, a first wiring connected to the output circuit via the first node, a second wiring connected to the output circuit via the first node, a first resistive element and a first switch connected to each other in series between the first wiring and the first signal line, and a second resistive element and a second switch connected to each other in series between the second wiring and the second signal line.

### BACKGROUND

### Field of the Technology

The disclosure relates to, for example, a display device, a photoelectric conversion apparatus, an electronic apparatus, a wearable device, and a moving body.

### Description of the Related Art

Japanese Patent Laid-Open No. 2021-89398 describes the following processes as a drive method for pixels in a display device. Specifically, the described processes include, after simultaneously writing, from respective signal output circuits, reference signal voltages for performing threshold correction of pixel driving transistors to pixels in a plurality of columns of pixels, sequentially writing, to the pixels, luminance signal voltages that are based on a video signal for every column.

With regard to voltage output circuits such as the signal output circuits, if a mismatch occurs between the output characteristics and the load, ringing may occur in transient waveforms at the time of a change in output voltage.

In the drive method described in Japanese Patent Laid-Open No. 2021-89398, since, between at the time of reference signal voltage writing and at the time of luminance signal voltage writing, the numbers of columns targeted for the respective signal voltage writing operations differ, loads connected to outputs of the signal output circuits differ. Therefore, in a case where the output characteristics of the signal output circuits are preliminarily optimized for the time of reference signal voltage writing, ringing may occur in voltage static waveforms of signal lines at the time of luminance signal voltage writing.

### SUMMARY

According to an aspect of the embodiments, a display device includes a pixel array in which a plurality of pixels each including a light-emitting element and a driving circuit which drives the light-emitting element is arranged in matrix form, a first signal line connected to pixels arranged in a first column of the pixel array, a second signal line connected to pixels arranged in a second column, an output circuit connected to a first node, a first wiring connected to the output circuit via the first node, a second wiring connected to the output circuit via the first node, a first resistive element and a first switch connected to each other in series between the first wiring and the first signal line, and a second resistive element and a second switch connected to each other in series between the second wiring and the second signal line.

Features of the disclosure will become apparent from the following description of embodiments with reference to the attached drawings. The following description of embodiments is described by way of example.

### BRIEF DESCRIPTION OF THE DRAWINGS

FIG. 1 is a schematic diagram of an example of a display device according to a first embodiment.

FIG. 2 is a circuit diagram of a configuration example of a pixel according to the first embodiment.

FIG. 3 is a timing chart used to explain an example of an operation of the pixel according to the first embodiment.

FIG. 4 is a timing chart used to explain an example of an operation of a signal line selector circuit according to the first embodiment.

FIG. 5 is a schematic diagram of an example of a display device according to a second embodiment.

FIG. 6 is a schematic diagram of an example of a display device according to a third embodiment.

FIG. 7A is a schematic sectional view illustrating an example of a pixel in a display device according to any one of the first to fourth embodiments. FIG. 7B is a schematic sectional view illustrating an example of a portion of the display device according to any one of the first to fourth embodiments.

FIG. 8 is a schematic diagram illustrating an example of an electronic apparatus according to any one of the first to fourth embodiments.

FIG. 9A is a schematic diagram illustrating an example of an image capturing apparatus according to any one of the first to fourth embodiments. FIG. 9B is a schematic diagram illustrating an example of an electronic apparatus according to any one of the first to fourth embodiments.

FIG. 10A is a schematic diagram illustrating an example of a display device according to any one of the first to fourth embodiments. FIG. 10B is a schematic diagram illustrating an example of a foldable display device according to any one of the first to fourth embodiments.

FIGS. 11A and 11B are schematic diagrams illustrating an example of an automobile including lighting equipment and a display unit according to any one of the first to fourth embodiments.

FIG. 12A is a schematic diagram illustrating an example of a wearable device according to any one of the first to fourth embodiments. FIG. 12B is a schematic diagram illustrating an example of a wearable device including an image capturing apparatus according to any one of the first to fourth embodiments.

FIG. 13A is a schematic diagram illustrating an example of a head-mounted display serving as a display device according to any one of the first to fourth embodiments. FIG. 13B is a schematic diagram illustrating an example in which a display device according to any one of the first to fourth embodiments is connected to an external device.

### DESCRIPTION OF THE EMBODIMENTS

Various embodiments, features, and aspects of the disclosure will be described in detail below with reference to the accompanying drawings. Furthermore, the following embodiments are not construed to limit the scope of the disclosure set forth in claims. While a plurality of features is described in each embodiment, not all of the plurality of features should not be construed to be essential for the disclosure, and, moreover, the plurality of features can be combined in an optional manner. Additionally, in the accompanying drawings, the same or similar constituent elements are assigned the respective same reference numerals, and any duplicate description thereof is omitted.

### First Embodiment

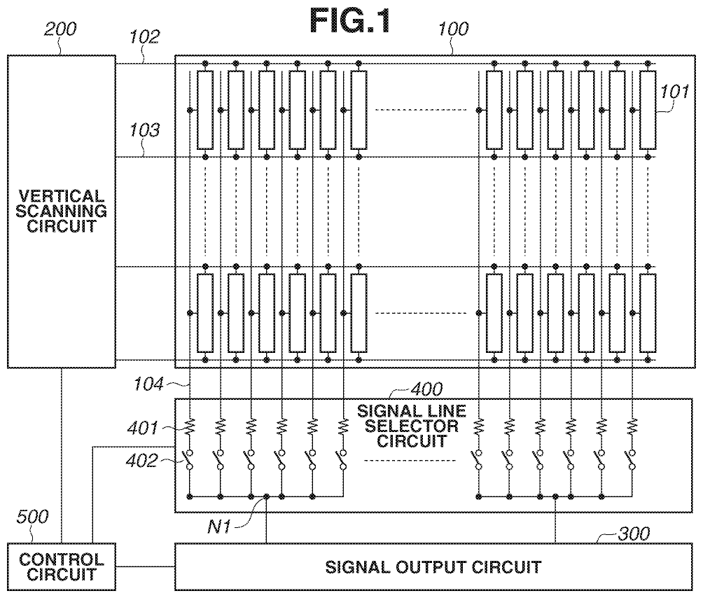

FIG. 1 is a schematic diagram of a display device according to a first embodiment. The display device according to the first embodiment includes a pixel array 100, a vertical scanning circuit 200, a signal output circuit 300, a signal line selector circuit 400, and a control circuit 500.

The pixel array 100 includes pixels 101 which are two-dimensionally arranged in matrix form over a plurality of rows and a plurality of columns. While, here, a case where the pixel array 100 illustrated in FIG. 1 is arranged in a rectangle is illustrated, the pixel array 100 can be of, for example, a polygonal shape or circular shape, and, as long as the pixel array 100 has a matrix form, the shape of the pixel array 100 is not limited to a rectangle.

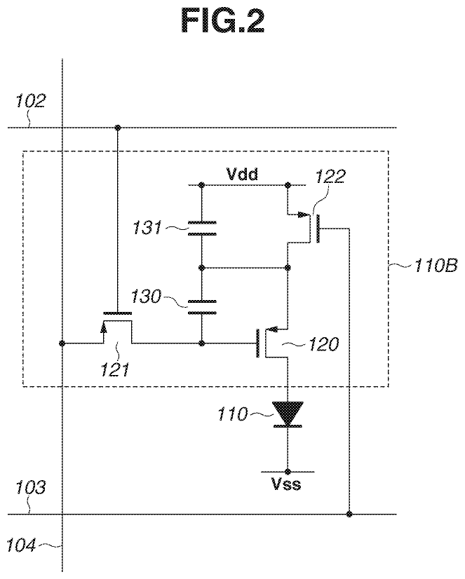

Each of the pixels 101 includes, as illustrated in FIG. 2, a light-emitting element 110, such as an organic light-emitting element (organic electroluminescence (EL) element), and a pixel driving circuit 110B, which drives the light-emitting element 110. In one embodiment, the pixel array 100 includes a plurality of pixels, and each pixel can include only one sub-pixel or, moreover, can include a plurality of sub-pixels. For example, each pixel can include three sub-pixels, i.e., a sub-pixel which emits red (R) light, a sub-pixel which emits green (G) light, and a sub-pixel which emits blue (B) light.

Here, a case where each pixel includes a plurality of sub-pixels is described, and the pixel 101 to be described here corresponds to a sub-pixel. However, the configuration of a pixel is not limited to a combination of sub-pixels of three original colors RGB, and, for example, can further include a pixel which emits white (W) light and can be another configuration.

In the pixel array 100, a plurality of write scanning lines 102 and a plurality of light-emission scanning lines 103 extend from the vertical scanning circuit 200 in the horizontal direction (row direction). Each pixel 101 is connected to a shared write scanning line 102 and a shared light-emission scanning line 103 for every row. Moreover, in the pixel array 100, a plurality of signal lines 104 extends in the vertical direction (column direction) from the signal line selector circuit 400, and each pixel 101 is connected to a shared signal line 104 for every column.

The vertical scanning circuit 200, the signal output circuit 300, and the signal line selector circuit 400 are controlled by the control circuit 500 and are caused to operate in synchronization with each other. The signal output circuit 300 can output a luminance signal voltage Vsig based on a video signal (not illustrated) input from the outside of the display device.

The signal line selector circuit 400 outputs the luminance signal voltage Vsig output from the signal output circuit 300 to a signal line 104 to which a corresponding pixel is connected out of the plurality of signal lines 104.

Here, a case where the signal line selector circuit 400 allocates a luminance signal voltage Vsig output from one output terminal of the signal output circuit 300 to six signal lines 104 is illustrated. However, the number of signal lines 104 to which the luminance signal voltage Vsig is output from one output terminal of the signal output circuit 300 is not limited to this number. In one embodiment, the luminance signal voltage Vsig output from one output terminal of the signal output circuit 300 only needs to be allocated to two or more signal lines 104.

The vertical scanning circuit 200 inputs a write signal to each pixel 101 via the write scanning line 102. To the pixel 101 in the row selected by the write signal, the luminance signal voltage Vsig supplied to the signal line 104 in each column is written. The vertical scanning circuit 200 further inputs a light-emission signal to each pixel 101 via the light-emission scanning line 103 and thus causes the pixel 101 in the row to which the luminance signal voltage Vsig has been written to effect light emission at a luminance that is based on the luminance signal voltage Vsig. The vertical scanning circuit 200, the signal output circuit 300, and the signal line selector circuit 400 repeat the above-mentioned luminance signal writing and light emission for every horizontal period while performing scanning row by row, and thus display an image that is based on a video signal in the pixel array 100.

FIG. 2 is a circuit diagram of a configuration example of the pixel 101 according to the first embodiment. The pixel 101 includes the light-emitting element 110 and the pixel driving circuit 110B. The pixel driving circuit 110B includes three transistors, i.e., a drive transistor 120, a write transistor 121, and a light-emission transistor 122, and two capacitive elements, i.e., a first capacitive element 130 and a second capacitive element 131.

While, in the following description, a case where the drive transistor 120 is connected to the anode of the light-emitting element 110 and all of the transistors included in the pixel 101 are P-type transistors is described, the pixel 101 in the first embodiment is not limited to this. For example, the drive transistor 120 can be connected to the cathode of the light-emitting element 110 and all of the transistors included in the pixel 101 can be N-type transistors. Moreover, another configuration can also be employed.

The cathode electrode of the light-emitting element 110 is connected to a power supply voltage Vss, and the drain of the drive transistor 120 is connected to the anode electrode of the light-emitting element 110. The source of the drive transistor 120 is connected to the drain of the light-emission transistor 122, and the gate of the drive transistor 120 is connected to the drain of the write transistor 121. Moreover, the gate of the drive transistor 120 is connected to a power supply voltage Vdd via the first capacitive element 130 and the second capacitive element 131, which are connected to each other in series.

The source of the light-emission transistor 122 is connected to the power supply voltage Vdd, and the source of the write transistor 121 is connected to the signal line 104. Moreover, the source of the drive transistor 120 is connected to a connection node between the first capacitive element 130 and the second capacitive element 131.

The write transistor 121 and the light-emission transistor 122 have the respective gates thereof which are logically controlled, and thus function as switches. The gate of the write transistor 121 is connected to the write scanning line 102, and turning-on and turning-off of the write transistor 121 are controlled by a write signal output from the vertical scanning circuit 200. The gate of the light-emission transistor 122 is connected to the light-emission scanning line 103, and turning-on and turning-off of the light-emission transistor 122 are controlled by a light-emission signal output from the vertical scanning circuit 200.

Next, an example of an operation of the pixel 101 is described. In the display device according to the first embodiment, the signal output circuit 300 can be configured to output a pixel signal in a first period and output a reference signal in a second period different from the first period. The reference signal (reference signal voltage) is written to a first signal line and a second signal line when both a first switch element 402 and a second switch element 402 (see FIG. 1) are in the on-state. Moreover, the pixel signal (pixel signal voltage) is written to the first signal line when the first switch element 402 is in the on-state and the second switch element 402 is in the off-state.

Here, in the pixel array 100, the first signal line and the second signal line are arranged at destinations into which a wiring extending from the signal output circuit 300 branches at a first node N1 (see FIG. 1). Between the first node N1 and the first signal line, a first resistive element 401 (see FIG. 1) and the first switch element 402 can be connected to each other in series. Moreover, between the first node N1 and the second signal line, a second resistive element 401 and the second switch element 402 can be connected to each other in series.

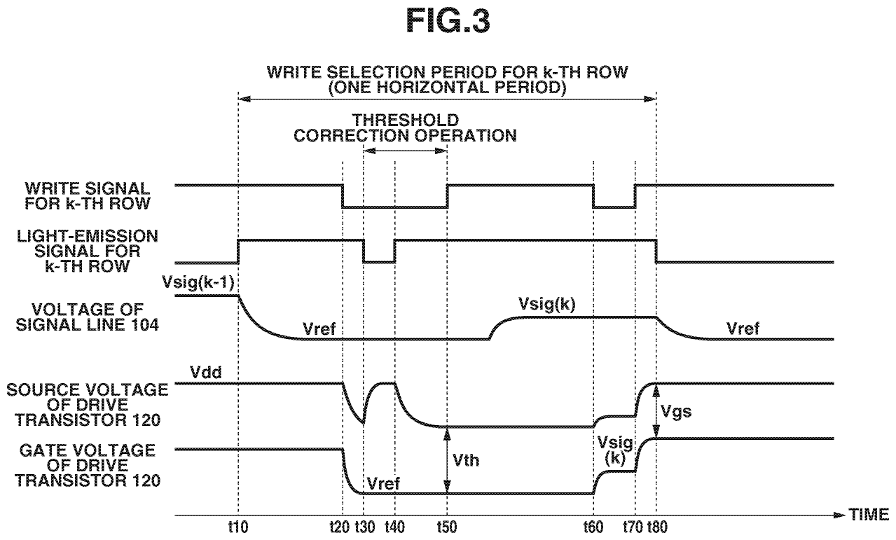

An example of a more specific operation of the pixel 101 is described with reference to the timing chart of FIG. 3. Here, a luminance signal voltage corresponding to a pixel 101 in the M-th row in an optional column is denoted by Vsig(M).

A period from time t10 to time t80 is one horizontal period in which the vertical scanning circuit 200 selects pixels 101 in the k-th row as a write row (hereinafter referred to as a “write selection period for the k-th row”).

An operation of a pixel 101 in the k-th row in an optional column is taken as an example for description. Before time t10, the write signal for the k-th row is at high level and the light-emission signal for the k-th row is at low level. Accordingly, the write transistor 121 is in the off-state and the light-emission transistor 122 is in the on-state. At this time, the drive transistor 120 and the light-emitting element 110 are maintaining the light-emission state of a previous frame. Moreover, the voltage of the signal line 104 is a luminance signal voltage Vsig(k−1).

At time t10, the write selection period for the k-th row starts, so that the light-emission signal for the k-th row becomes high in level. At this time, the light-emission transistor 122 enters into the off-state, so that a path for supplying a current from the power supply voltage Vdd to the light-emitting element 110 via the drive transistor 120 is blocked. Accordingly, the light-emitting element 110 enters into a non-light-emission state.

Next, in a period from time t10 to time t20, the voltage of the signal line 104 changes to a reference signal voltage Vref. After that, at time t20, the write signal for the k-th row becomes low in level. At this time, the write transistor 121 enters into the on-state, so that, in a period from time t20 to time t30, the reference signal voltage Vref is written from the signal line 104 to the gate of the drive transistor 120.

In a subsequent period from t30 to time t50, the pixel 101 performs a threshold correction operation. The threshold voltage Vth of the drive transistor 120 is varying due to manufacturing variations thereof. The variation of the threshold voltage Vth of the drive transistor 120 may cause non-uniformity of display. Performing the threshold correction operation enables reducing non-uniformity of display caused by the variation of the threshold voltage Vth of the drive transistor 120.

In a period from time t30 to time t40, the light-emission signal for the k-th row becomes low in level. The light-emission transistor 122 enters into the on-state, and the source voltage of the drive transistor 120 becomes the power supply voltage Vdd by time t40. The reference signal voltage Vref is set in such a manner that the drain-source voltage of the drive transistor 120 at that time becomes higher than or equal to the threshold voltage Vth.

Therefore, a current flows from the source of the drive transistor 120 to the drain thereof and then to the light-emitting element 110.

At time t40, the light-emission signal for the k-th row becomes high in level. The light-emission transistor 122 enters into the off-state, and the source voltage of the drive transistor 120 becomes lower with time due to the current flowing from the source of the drive transistor 120 to the drain thereof. Along with the lowering of the source voltage of the drive transistor 120, the gate-source voltage thereof becomes lower, and, when the gate-source voltage thereof reaches about the threshold voltage Vth, the variation in the source voltage thereof converges.

At time t50, when the write signal for the k-th row becomes high in level, the write transistor 121 enters into the off-state. At this time, the gate-source voltage of the drive transistor 120 at time t50, i.e., the threshold voltage Vth of the drive transistor 120, is retained by the first capacitive element 130.

After that, the pixel 101 performs an operation based on the threshold voltage Vth retained by the first capacitive element 130, so that the variation of the threshold voltage Vth of the drive transistor 120 is corrected.

Furthermore, in a period from time t30 to time t50, a current may flow to the light-emitting element 110 and thus cause unintended light emission. Therefore, if, to reduce the influence on the amount of light emission, the period from time t30 to time t50 is set shorter relative to one frame period, it is possible to shorten a period of the unintended light emission. This light emission time is sufficiently short as compared with a desired light emission time for pixels and, therefore, does not severely damage displaying, but it is favorable that the light emission time is short.

After the threshold correction operation, in a period from time t50 to time t60, the voltage of the signal line 104 changes to a luminance signal voltage Vsig(k). Then, at time t60, the write signal for the k-th row becomes low in level. At this time, the write transistor 121 enters into the on-state, and, in a period from t60 to time t70, the luminance signal voltage Vsig(k) is written from the signal line 104 to the gate of the drive transistor 120.

At time t70, the write signal for the k-th row becomes high in level. The write transistor 121 light-emission transistor 122 enters into the off-state, so that the luminance signal voltage Vsig(k) is retained by the first capacitive element 130.

At time t80, the write selection period for the k-th row ends, so that the light-emission signal for the k-th row becomes low in level. At this time, the light-emission transistor 122 enters into the on-state, and the drive transistor 120 supplies a current to the light-emitting element 110 based on the gate-source voltage Vgs thereof. Here, when the capacitance value of the first capacitive element 130 is denoted by C1 and the capacitance value of the second capacitive element 131 is denoted by C2, the gate-source voltage Vgs of the drive transistor 120 is expressed by the following equation (1).

Vgs=Vth−{Vsig(k)−Vref}×C2/(C1+C2) (1)

Accordingly, the light-emitting element 110 performs light emission at a luminance that is based on the corrected threshold voltage Vth of the drive transistor 120 and the luminance signal voltage Vsig(k). After time t80, until the next frame, this light emission state continues.

As described above, in the pixel 101 in the first embodiment, the light-emitting element 110 performs light emission based on the reference signal voltage Vref and the luminance signal voltage Vsig.

Next, an example of the configuration of the display device according to the first embodiment is described. The display device according to the first embodiment includes the pixel array 100 in which a plurality of pixels is arranged in matrix form. Each pixel 101 includes the light-emitting element 110 and the pixel driving circuit 110B, which drives the light-emitting element 110. Moreover, the display device according to the first embodiment includes a first signal line connected to pixels arranged in the first column of the pixel array 100 and a second signal line connected to pixels arranged in the second column, different from the first column, of the pixel array 100.

Additionally, the display device according to the first embodiment includes the signal output circuit 300, which is electrically connected to the first node N1, a first wiring connected to the signal output circuit 300 via the first node N1, and a second wiring connected to the signal output circuit 300 via the first node N1. Between the first wiring and the first signal line, the first resistive element 401 and the first switch element 402 are connected to each other in series, and, between the second wiring and the second signal line, the second resistive element 401 and the second switch element 402 are connected to each other in series.

The signal line selector circuit 400 is described more specifically. The signal line selector circuit 400 includes, as illustrated in FIG. 1, a resistive element 401 and a switch element 402 which are provided in association with each column of the pixel array 100. Here, the resistive element 401 can be a resistor such as a polysilicon resistor or a diffused resistor which is used in a semiconductor process. However, a resistor not separately manufactured, such as a parasitic resistor for a signal line or wiring, is assumed not to be included in the resistive element 401 in the specification.

The resistive element 401 and the switch element 402 in each column are connected to each other in series, and one end of the set including the resistive element 401 and the switch element 402 is connected to the signal line 104 in each column. The other end of the set including the resistive element 401 and the switch element 402 connected to each other in series is connected to the same output terminal of the signal output circuit 300 for six column via the first node N1. Each wiring extending from the signal output circuit 300 branches into a plurality of wirings. Here, an example in which each wiring extending from the signal output circuit 300 branches into six wirings is illustrated. Therefore, the first wiring and the second wiring are some of wirings into which each wiring extending from an output terminal of the signal output circuit 300 branches at the first node N1 and are two wirings out of the six wirings. Therefore, the first wiring and the second wiring can be adjacent to each other.

While, in FIG. 1, a case where the resistive element 401 is connected to the signal line 104 and the switch element 402 is connected to the signal output circuit 300 is illustrated, the switch element 402 can be connected to the signal line 104 and the resistive element 401 can be connected to the signal output circuit 300. Furthermore, the turning-on and turning-off states of the switch element 402 are controlled by a switch control signal output from the control circuit 500.

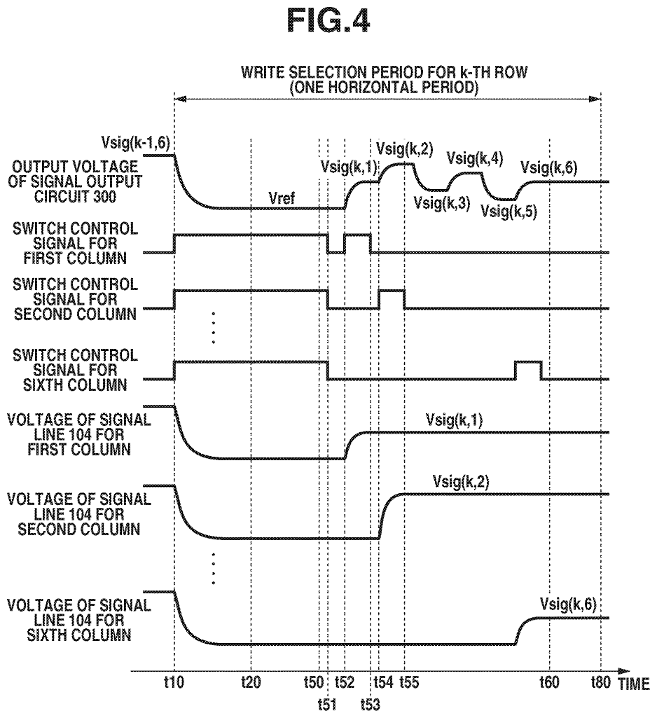

An operation of the above-mentioned signal line selector circuit 400 is described with reference to the timing chart of FIG. 4. Here, a luminance signal voltage corresponding to a pixel 101 in the M-th row in the N-th column is denoted by Vsig(M, N). Moreover, time assigned with the same reference character as that in FIG. 3 represents the same time as that in FIG. 3.

The period from time t10 to time t80 is a write selection period for the k-th row. In the following description, operations for the first column to the sixth column are taken as an example for description. Operations for the seventh column and subsequent columns are similar to the operations for the first column to the sixth column. For example, operations for the seventh column, the thirteenth column, . . . , are similar to the operation for the first column.

Before time t10, the signal output circuit 300 outputs a luminance signal voltage Vsig(k−1, 6) corresponding to the sixth column in the previous row. Moreover, the switch control signal is at low level. Here, the switch element 402 is controlled to be in the off-state in response to the switch control signal being at low level and to be in the on-state in response to the switch control signal being at high level. Therefore, all of the switch elements 402 in the first column to the sixth column are in the off-state.

At time t10, the switch control signals for the first column to the sixth column become high in level. At this time, the switch elements 402 in the first column to the sixth column enter into the on-state. Accordingly, to the output terminal of the signal output circuit 300, the signal lines 104 for the first column to the sixth column and the resistive elements 401 in the respective column are connected as loads.

In a period from time t10 to time t20, the signal output circuit 300 changes the output voltage thereof to a reference signal voltage Vref. The voltage of the signal line 104 is stabilized, by time t20, at the reference signal voltage Vref by a voltage waveform determined by the output characteristics of the signal output circuit 300 and the load thereon.

In a period from time t20 to time t50, the reference signal voltage Vref continues to be output from the signal output circuit 300 to the signal line 104. The reference signal voltage Vref having been output to the signal line 104 in this period is written to the pixel 101, so that the pixel 101 performs a threshold correction operation based on the written reference signal voltage Vref.

At time t51 after the threshold correction operation, the switch control signals for the first column to the sixth column become low in level. At this time, the switch elements 402 enter into the off-state.

In one embodiment, at subsequent time t52, only the switch control signal for the first column becomes high in level. At this time, the switch element 402 for the first column enters into the on-state. Accordingly, to the output terminal of the signal output circuit 300, the signal line 104 for the first column and the resistive element 401 for the first column are connected as a load.

In a period from time t52 to time t53, the signal output circuit 300 changes the output voltage thereof to a luminance signal voltage Vsig(k, 1). The voltage of the signal line 104 for the first column is stabilized, by time t53, at the luminance signal voltage Vsig(k, 1) by a voltage waveform determined by the output characteristics of the signal output circuit 300 and the load thereon.

At time t53, the switch control signal for the first column becomes low in level. At this time, the switch element 402 for the first column enters into the off-state. Here, the signal line 104 has, generally, a large parasitic capacitance of greater than or equal to 10 picofarad (pF). Therefore, the signal line 104 for the first column retains the luminance signal voltage Vsig(k, 1) even after time t53.

Next, at time t54, the switch control signal for the second column becomes high in level. Moreover, by time t55, the signal output circuit 300 changes the output voltage thereof to a luminance signal voltage Vsig(k, 2). After that, at time t55, the switch control signal for the second column becomes low in level. In response to an operation performed at time t54 to time t55, at and after time t55, the signal line 104 for the second column retains the luminance signal voltage Vsig(k, 2) in a similar way to that for the first column. In a period from then until time t60, luminance signal voltages Vsig(k, 3) to Vsig(k, 6) are progressively retained in sequence at the signal lines 104 for the third to sixth columns.

At and after time t60, the luminance signal voltage Vsig(k) retained at each signal line 104 is written to the pixel 101, so that, in the pixel 101, the light-emitting element 110 performs light emission based on the written luminance signal voltage Vsig(k).

When the voltage of the signal line 104 changes to the reference signal voltage Vref or the luminance signal voltage Vsig, the voltage static waveform of the signal line 104 is determined by the output characteristics of the signal output circuit 300 and the load thereon. In the case of a general display device, the signal line selector circuit 400 does not include the resistive elements 401 and the signal line 104 for each column is connected to the output terminal of the signal output circuit 300 via the switch element 402 for each column.

Here, the parasitic capacitance value of the signal line 104 for one column is denoted by C. In a case where the signal line selector circuit 400 does not include the resistive elements 401, the load connected to one output terminal of the signal output circuit 300 is 6 C at the time of writing of the reference signal voltage and is C at the time of writing of the luminance signal voltage. Therefore, in a case where the output characteristics of the signal output circuit 300 has been optimally designed for the time of writing of the reference signal voltage Vref, ringing may occur in the voltage static waveform of the signal line 104 at the time of writing of the luminance signal voltage Vsig.

In recent years, with regard to display devices, periods available for writing of a reference signal and a luminance signal are becoming shorter due to an increase in pixel count and an increase in frame rate. Therefore, if ringing occurs at the time of writing of the luminance signal voltage, the luminance signal voltage may not become sufficiently static within a predetermined signal voltage writing period and, therefore, an error may occur in a luminance signal voltage to be written to the pixel. This error occurs due to characteristics variations caused by an output portion and an output path of the signal output circuit and causes the deterioration of a display quality such as display unevenness.

Here, writing of the luminance signal voltage Vsig in the first embodiment is taken as an example for description. When the resistance value of the resistive element 401 is denoted by R, at the time of writing of the luminance signal voltage, a low-pass filter with a time constant of “R×C” is formed by the parasitic capacitance of the signal line 104 and the resistive element 401. Accordingly, in the case of the first embodiment, it is possible to prevent or reduce ringing of the signal line 104 in the luminance signal voltage writing.

Furthermore, in Japanese Patent Laid-Open No. 2019-101084, a configuration in which a resistive element is arranged in front of the branch point (first node N1) of a wiring from the signal output circuit 300, i.e., between the output terminal of the signal output circuit 300 and the branch point (first node N1) for respective columns, is described. Even such a configuration can prevent or reduce, to some extent, ringing occurring at the time of writing of the luminance signal voltage. Moreover, in the configuration described in Japanese Patent Laid-Open No. 2019-101084, the number of resistive elements to be inserted is smaller than that in the first embodiment.

However, in the configuration described in Japanese Patent Laid-Open No. 2019-101084, in writing of the reference signal voltage, a low-pass filter with a time constant of “R×6 C” is formed. Along with this, the voltage static waveform of the signal line 104 becomes dull and the threshold correction operation may be performed without the reference signal voltage Vref becoming sufficiently static.

As a result, no accurate threshold correction is performed, so that the display quality may deteriorate.

On the other hand, in the case of the first embodiment, the time constant of a low-pass filter which is formed at the time of writing of the reference signal voltage Vref is “(R/6)×6 C”. Therefore, it is possible to reduce the low-pass filter function as compared with the above-mentioned configuration. As a result, it is also possible to prevent or reduce the dullness of the voltage static waveform at the time of writing of the reference signal voltage while maintaining a ringing reduction or prevention effect at the time of writing of the luminance signal voltage.

As described above, in the configuration in the first embodiment, by connecting the output terminal of the signal output circuit 300 to the signal lines 104 via the resistive elements provided for the respective columns, it is possible to prevent or reduce ringing occurring at the time of writing of the luminance signal voltage and reduce the deterioration of the display quality. Moreover, it is also possible to prevent or reduce the dullness of the voltage static waveform at the time of writing of the reference signal voltage.

Furthermore, while, in the first embodiment, an example in which the signal lines 104 which are connected to the same output terminal of the signal output circuit 300 are adjacent to each other has been described, the first embodiment is not limited to this connection. For example, the first embodiment also includes a case where the signal lines 104 which are connected to the same output terminal are not adjacent to each other, such as a case where signal lines 104 corresponding to pixels in which the colors of light to be emitted are the same are connected to the same output terminal.

Moreover, while, in the first embodiment, a case where the reference signal voltage Vref is used for the pixel threshold correction has been described, the first embodiment is not limited to this case. In one embodiment, the reference signal voltage only needs to be written from the same output terminal of the signal output circuit 300 to a plurality of signal lines 104, and, for example, driving in the first embodiment also includes a case where the reference signal voltage Vref is used for pre-charge of the signal lines 104.

### Second Embodiment

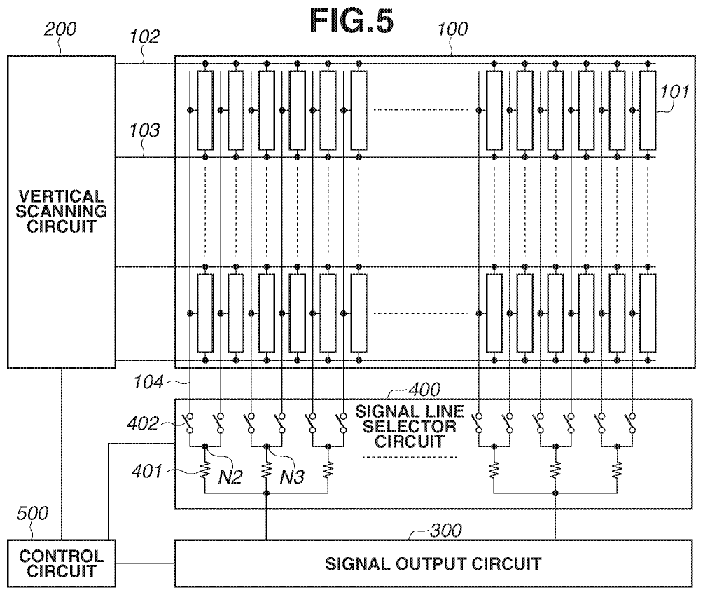

FIG. 5 is a schematic diagram of a display device according to a second embodiment. Portions to be described in a manner similar to those in the first embodiment, such as the configurations, functions, materials, and advantageous effects of the second embodiment similar to those in the first embodiment, are omitted from description here. The display device according to the second embodiment differs in the configuration of the signal line selector circuit 400 from that in the first embodiment. In the following description, the signal line selector circuit 400, which differs from that in the first embodiment, is described.

The signal line selector circuit 400 includes switch elements 402 for the respective columns and resistive elements 401 for every two columns. One end of the switch element 402 is connected to the signal line 104 for each column. Moreover, the respective other ends of the switch elements 402 are connected to each other for every two columns and are connected to one end of the resistive element 401. The respective other ends of the resistive elements 401 are connected to each other for every three resistive elements 401 and are connected to one output terminal of the signal output circuit 300.

For example, the display device according to the second embodiment includes a third signal line connected to pixels arranged in a third column different from the first column and the second column of the pixel array 100 and a fourth signal line connected to pixels arranged in a fourth column different from the first to third columns of the pixel array 100. Between the first wiring and the third signal line, the first resistive element 401 is arranged, and, between the second wiring and the fourth signal line, the second resistive element 401 is arranged.

Moreover, between the first resistive element 401 and the third signal line, a third switch element 402 is arranged, and, between the second resistive element 401 and the fourth signal line, a fourth switch element 402 is arranged. The first switch element 402, the third switch element 402, and the first resistive element 401 are connected to a second node N2, and the second switch element 402, the fourth switch element 402, and the second resistive element 401 are connected to a third node N3.

In the configuration example of the display device illustrated in FIG. 5, the first resistive element 401 is arranged between the signal output circuit 300 and the second node N2, and the second resistive element 401 is arranged between the signal output circuit 300 and the third node N3.

The switch element 402 in the second embodiment performs an operation similar to that in the first embodiment. Accordingly, at the time of writing of the luminance signal voltage Vsig, a low-pass filter with a time constant of “R×C” is formed by the parasitic capacitance of one resistive element 401 and one signal line 104. Moreover, at the time of writing of the reference signal voltage Vref, a low-pass filter with a time constant of “(R/3)×6 C” is formed by the parasitic capacitance of three resistive elements 401 and six signal lines 104.

Therefore, as with the first embodiment, it is possible to, while preventing or reducing the dullness of the voltage static waveform at the time of writing of the reference signal voltage, prevent or reduce ringing occurring at the time of writing of the luminance signal voltage and thus reduce the deterioration of the display quality.

### Third Embodiment

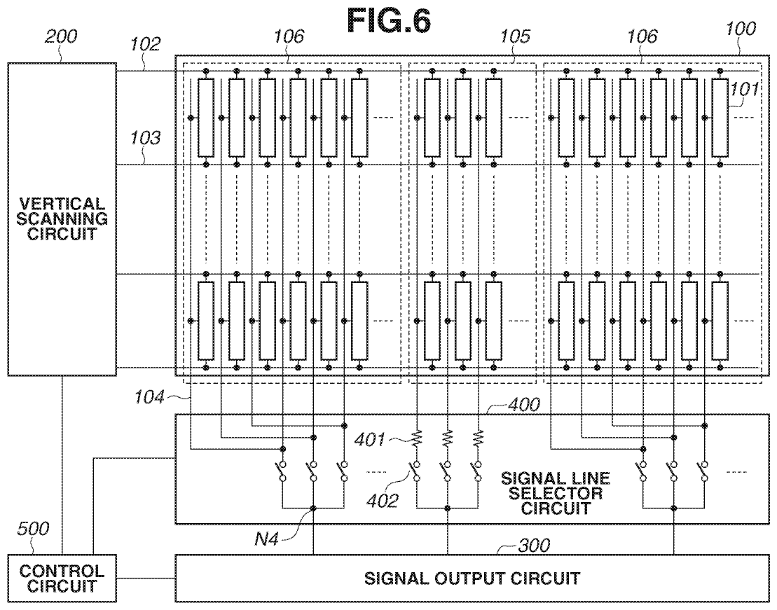

An example of a configuration of a display device according to a third embodiment is described with reference to FIG. 6. Portions to be described in a duplicated manner as in the first embodiment and the second embodiment, such as the configurations, functions, materials, and advantageous effects of the second embodiment similar to those in the first embodiment and the second embodiment, are omitted from description here. FIG. 6 is a schematic diagram of the display device according to the third embodiment.

Nowadays, a technique which, for the purpose of, for example, an increase in performance of a graphics processing unit (GPU), in one embodiment, a reduction in data communication speed, or reduced power consumption, displays only some display regions of a display device at high resolution and display the other regions thereof at low resolution is known. The third embodiment relates to this technique, and the pixel array 100 includes two pixel regions, i.e., a pixel region 105 and a pixel region 106, which differ in display resolution.

While, here, for ease of the description about the features of the disclosure, in one embodiment, a case where the pixel region 105 and the pixel region 106 have respective resolutions which differ in only the horizontal direction (row direction) is illustrated, the third embodiment is not limited to this case. For example, in addition to the horizontal direction (row direction), even in the vertical direction (column direction), the pixel region 105 can be arranged between the pixel regions 106.

The display device according to the third embodiment includes a fifth signal line connected to pixels arranged in a fifth column different from the first column and the second column of the pixel array 100 and a sixth signal line connected to pixels arranged in a sixth column different from the first column, the second column, and the fifth column of the pixel array 100. Moreover, the fifth signal line is connected to the signal output circuit 300 via a fourth node N4, and the sixth signal line is connected to the signal output circuit 300 via the fourth node N4.

Between the fourth node N4 and the fifth signal line, a fifth switch element 402 is arranged and no resistive element is arranged. Moreover, between the fourth node N4 and the sixth signal line, a sixth switch element 402 is arranged and no resistive element is arranged.

A configuration example of the display device according to the third embodiment is described in more detail. In the pixel array 100, sub-pixels are allocated in the order of R, G, and B from the first column. Moreover, the pixel array 100 includes the pixel region 105 and the pixel region 106. The respective configurations of the pixel region 105 and the pixel region 106 in the pixel array 100 are the same. A difference between the pixel region 105 and the pixel region 106 is a configuration of the signal line selector circuit 400 connected thereto.

In a portion of the signal line selector circuit 400 corresponding to the pixel region 105, the resistive element 401 and the switch element 402 which are connected to each other in series are provided for each column. One end of the set including the resistive element 401 and the switch element 402 which are connected to each other in series is connected to the signal line 104 for each column, and the respective other ends of the sets each including the resistive element 401 and the switch element 402 which are connected to each other in series are connected to each other for every three column and are connected to one output terminal of the signal output circuit 300.

On the other hand, in a portion of the signal line selector circuit 400 corresponding to the pixel region 106, three switch elements 402 are provided for every six columns.

The first to sixth columns are described as an example. To one end of the first switch element 402, the signal lines 104 for the first column and the fourth column are connected. To one end of the second switch element 402, the signal lines 104 for the second column and the fifth column are connected. To one end of the third switch element 402, the signal lines 104 for the third column and the sixth column are connected. Thus, the signal lines 104 for the same color adjacent to each other are connected to the same switch element 402. Furthermore, the respective other ends of three switch elements 402 are connected to each other and are connected to one output terminal of the signal output circuit 300.

In the above-described configuration, in each of the pixel region 105 and the pixel region 106, to one output terminal of the signal output circuit 300, three switch elements 402 are connected. As with the first embodiment, in one horizontal period, after outputting the reference signal voltage Vref, the signal output circuit 300 outputs three luminance signal voltages Vsig in sequence. Along with this, the three switch elements 402 are controlled to simultaneously enter into the on-state at the time of writing of the reference signal voltage and are controlled to enter into the on-state one by one at the time of writing of the luminance signal voltage.

Accordingly, in the pixel region 105, luminance signal voltages Vsig are allocated for the respective columns, so that the pixel array 100 displays an image at a resolution corresponding to the number of pixels. On the other hand, in the pixel region 106, luminance signal voltages Vsig are allocated for every two columns of the same color, so that the pixel array 100 displays an image with a low resolution in the horizontal direction.

Here, loads on the signal output circuit 300 in the respective regions including the pixel region 105 and the pixel region 106 are taken as an example for description. In a case where the signal line selector circuit 400 includes no resistive element 401, if the parasitic capacitance value of one signal line is denoted by C, in the pixel region 105, the load at the time of writing of the luminance signal voltage is C and the load at the time of writing of the reference signal voltage is 3 C. On the other hand, in the pixel region 106, the load at the time of writing of the luminance signal voltage is 2 C and the load at the time of writing of the reference signal voltage is 6 C. Due to different loads for each, in one embodiment, only at the time of writing of the luminance signal voltage in the pixel region 105, ringing may occur in the voltage static waveform of the signal line 104.

In the configuration in the third embodiment, with respect to only the columns corresponding to the pixel region 105, the signal line 104 and the output terminal of the signal output circuit 300 are connected to each other via the resistive element 401 provided for each of such column. Therefore, at the time of writing of the reference signal voltage and at the time of writing of the luminance signal voltage in the pixel region 106, the pixel region 106 is not affected by the insertion of the resistive element 401.

Accordingly, preventing or reducing ringing occurring at the time of writing of the luminance signal voltage in the pixel region 105 without causing the deterioration of voltage static waveforms in the other pixel region enables reducing the deterioration of the display quality.

Furthermore, while, in the third embodiment, a case where no resistor is provided in columns corresponding to the pixel region 106 has been described, the display device in the disclosure is not limited to this. It can also be considered that resistors different from those provided for columns corresponding to the pixel region 105 are provided for columns corresponding to the pixel region 106. At this time, resistors can be connected to portions different from those for columns corresponding to the pixel region 105.

For example, resistors can be connected to terminals on the signal line side of the respective switch elements 402 or can be connected to terminals on the signal output circuit side of the respective switch elements 402. Additionally, resistors can be provided at the respective output portions of the signal line selector circuit 400 for the signal lines 104.

Moreover, while, here, a case where there are two pixel regions differing in resolution has been described, the third embodiment is not limited to this. A similar advantageous effect can also be obtained even in a case where loads differ depending on pixel regions.

### Fourth Embodiment

Next, an organic light-emitting device which is applicable to any one of the first to third embodiments is described as a display device according to a fourth embodiment. An organic light-emitting element can be used as the light-emitting element 110 included in each pixel. The organic light-emitting element according to the fourth embodiment includes, for example, a first electrode, a second electrode, and an organic compound layer arranged between the first and second electrodes. One of the first electrode and the second electrode is an anode, and the other is a cathode. In the organic light-emitting element according to the fourth embodiment, the organic compound layer can be either a single layer or a stacked body composed of a plurality of layers as long as the organic compound layer includes a light-emitting layer. Here, in a case where the organic compound layer is a stacked body composed of a plurality of layers, the organic compound layer can include, in addition to the light-emitting layer, for example, a hole injection layer, a hole transport layer, an electron blocking layer, a hole/exciton blocking layer, an electron transport layer, and an electron injection layer. Moreover, the light-emitting layer can be a single layer or a stacked body composed of a plurality of layers. In a case where the light-emitting layer is composed of a plurality of layers, the light-emitting layer can include a charge generation layer between the light-emitting layers. The charge generation layer can be made of a compound having a lowest unoccupied molecular orbital (LUMO) lower than that of the hole transport layer, and the LUMO of the charge generation layer can be lower than the highest occupied molecular orbital (HOMO) of the hole transport layer. Here, the molecular orbital energy of the organic compound layer can be the molecular orbital energy of the organic compound with the largest weight ratio in the organic compound layer.

### Configuration of Organic Light-Emitting Element

The organic light-emitting element is provided by forming, on the substrate thereof, an insulating layer, a first electrode, an organic compound layer, and a second electrode. On the cathode of the organic light-emitting element, for example, a protection layer, a color filter, or a microlens can be provided.

In a case where the color filter is provided, a planarizing layer can be provided between the protection layer and the color filter. The planarizing layer can be made of, for example, acrylic resin. The same also applies to a case where the planarizing layer is provided between the color filter and the microlens.

### Substrate

For example, quartz, glass, a silicon wafer, a resin, or a metal can be used as the substrate. Moreover, a switching element such as a transistor and a wiring can be provided on the substrate, and an insulating layer can be provided on the transistor and the wiring. The insulating layer can be made of any material as long as a contact hole is able to be formed in such a manner that a wiring is able to be formed between the insulating layer and the first electrode and the insulation from an unconnected wiring is able to be ensured. For example, a resin such as polyimide, silicon oxide, or silicon nitride can be used as the material of the insulating layer.

### Electrodes

A pair of electrodes can be used as the electrodes. The pair of electrodes can be an anode and a cathode.

In a case where an electric field is applied in the direction in which the organic light-emitting element emits light, the electrode having a high potential is the anode, and the other is the cathode. Moreover, it can also be said that the electrode which supplies holes to the light-emitting layer is the anode and the electrode which supplies electrons is the cathode.

As the constituent material of the anode, a material having a work function as large as possible is favorably used. For example, a metal such as gold, platinum, silver, copper, nickel, palladium, cobalt, selenium, vanadium, or tungsten, a mixture containing some or all of them, an alloy obtained by combining some or all of them, or a metal oxide such as tin oxide, zinc oxide, indium oxide, indium tin oxide (ITO), or zinc indium oxide can be used. Moreover, a conductive polymer such as polyaniline, polypyrrole, or polythiophene can also be used.

One of these electrode materials can be used singly, or two or more of them can be used in combination. Moreover, the anode can be formed by a single layer or can be formed by a plurality of layers.

In a case where the anode is used as a reflective electrode, for example, chromium, aluminum, silver, titanium, tungsten, molybdenum, an alloy of some or all of such materials, or a material formed by stacking some or all of such materials can be used. The above materials can function as a reflective film having no role as an electrode. Moreover, in a case where the anode is used as a transparent electrode, for example, an oxide transparent conductive layer made of indium tin oxide (ITO) or indium zinc oxide can be used, but the disclosure is not limited to these.

A photolithography technique can be used to form an electrode.

On the other hand, as the constituent material of the cathode, a material having a small work function is favorably used. Examples of such a material include an alkali metal such as lithium, an alkaline earth metal such as calcium, a metal such as aluminum, titanium, manganese, silver, lead, or chromium, and a mixture containing some or all of them. Alternatively, an alloy obtained by combining some or all of these metals can also be used. For example, a magnesium-silver alloy, an aluminum-lithium alloy, an aluminum-magnesium alloy, a silver-copper alloy, or a zinc-silver alloy can be used. A metal oxide such as indium tin oxide (ITO) can also be used. One of these electrode materials can be used singly, or two or more of them can be used in combination. Moreover, the cathode can have a single-layer structure or can have a multilayer structure. Among others, silver is favorably used, and, to reduce the aggregation of silver, a silver alloy is more favorably used. The mixing ratio of the alloy is not limited as long as the aggregation of silver can be reduced. For example, the mixing ratio between silver and another metal can be, for example, 1:1 or 3:1.

The cathode can be used as a top emission element using an oxide conductive layer made of, for example, ITO, or can be used as a bottom emission element using a reflective electrode made of, for example, aluminum (Al), and is not particularly limited. The method of forming the cathode is not particularly limited, but direct current sputtering or alternating current sputtering is more favorably used since the good film coverage is provided and the resistance is easily lowered.

### Pixel Isolation Layer

A pixel isolation layer included in the organic compound layer is formed by a silicon nitride (SiN) film, a silicon oxynitride (SiON) film, or a silicon oxide (SiO) film formed with use of a chemical vapor deposition method (CVD method).

To increase the resistance in the in-plane direction of the organic compound layer, the organic compound layer, especially the hole transport layer, is favorably thinly deposited on the side wall of the pixel isolation layer. Specifically, the organic compound layer is able to be deposited so as to have a thin film thickness on the side wall by increasing the taper angle of the side wall of the pixel isolation layer or the film thickness of the pixel isolation layer to increase vignetting during vapor deposition.

On the other hand, it is favorable to adjust the taper angle of the side wall of the pixel isolation layer or the film thickness of the pixel isolation layer to the extent that no space is formed in the protection layer formed on the pixel isolation layer. Since no space is formed in the protection layer, it is possible to reduce the generation of defects in the protection layer. Since the generation of defects in the protection layer is reduced, it is possible to reduce a decrease in reliability caused by, for example, the generation of a dark spot or the occurrence of a conductive failure of the second electrode.

According to the fourth embodiment, even if the taper angle of the side wall of the pixel isolation layer is not acute, it is possible to effectively prevent or reduce the leakage of charges to an adjacent pixel. As a result of this consideration, it has been found that the taper angle of greater than or equal to 60° and less than or equal to 90° can sufficiently reduce the occurrence of defects. In this embodiment, the film thickness of the pixel isolation layer is greater than or equal to 10 nanometers (nm) and less than or equal to 150 nm. Moreover, a similar advantageous effect can be obtained in a configuration including only pixel electrodes without the pixel isolation layer. However, in this case, the film thickness of the pixel electrode is favorably set smaller than or equal to half the film thickness of the organic layer or the end portion of the pixel electrode is favorably formed to have a forward tapered shape of less than 60° because the short circuit of the organic light-emitting element can be reduced.

### Organic Compound Layer

The organic compound layer can be formed by a single layer or can be formed by a plurality of layers. In a case where the organic compound layer includes a plurality of layers, the layers can be called a hole injection layer, a hole transport layer, an electron blocking layer, a light-emitting layer, a hole blocking layer, an electron transport layer, and an electron injection layer depending on the respective functions of the layers. The organic compound layer is mainly formed from an organic compound but can contain inorganic atoms or an inorganic compound. For example, the organic compound layer can contain, for example, copper, lithium, magnesium, aluminum, iridium, platinum, molybdenum, or zinc. The organic compound layer can be arranged between the first electrode and the second electrode, and can be arranged in contact with the first electrode and the second electrode.

In a case where the organic compound layer includes a plurality of light-emitting layers, the organic compound layer can include a charge generation portion between the first light-emitting layer and the second light-emitting layer. The charge generation portion can contain an organic compound with a lowest unoccupied molecular orbital energy (LUMO) of −5.0 electron volts (eV) or less. The same also applies to a case where the organic compound layer includes a charge generation portion between the second light-emitting layer and the third light-emitting layer.

### Protection Layer

A protection layer can be provided on the second electrode. For example, by adhering glass provided with a moisture absorbing agent onto the second electrode, it is possible to reduce the permeation of, for example, water into the organic compound layer and reduce the occurrence of display defects. Moreover, as another embodiment, a passivation film made of, for example, silicon nitride can be provided on the cathode to reduce the permeation of, for example, water into the organic compound layer. For example, the protection layer can be formed by forming the cathode, transferring the cathode to another chamber without breaking a vacuum, and forming a silicon nitride film having a thickness of 2 micrometers (μm) by a CVD method. The protection layer can be provided using an atomic deposition method (ALD method) after deposition using the CVD method. The material of the film by the ALD method is not limited but can be, for example, silicon nitride, silicon oxide, or aluminum oxide. A silicon nitride film can be further formed by the CVD method on the film formed by the ALD method. The film formed by the ALD method can have a film thickness smaller than that of the film formed by the CVD method. Specifically, the film thickness of the film formed by the ALD method can be 50% or less of the film thickness of the film formed by the CVD method, or can further be 10% or less thereof.

### Color Filter

A color filter can be provided on the protection layer. For example, a color filter prepared with the size of the organic light-emitting element taken into consideration can be provided on a different substrate, and the different substrate can be bonded to a substrate provided with the organic light-emitting element, or a color filter can be patterned on the above-mentioned protection layer with use of a photolithography technique. The color filter can be formed from a polymeric material.

### Planarizing Layer

The organic light-emitting element can include a planarizing layer between the color filter and the protection layer. The planarizing layer is provided to reduce the unevenness of a layer under the planarizing layer. The planarizing layer may be called a material resin layer without the purpose thereof being limited. The planarizing layer can be formed from an organic compound, and can be made of a low-molecular material or a polymeric material, but a polymeric material is favorable.

The planarizing layers can be provided above and below the color filter, and the same or different constituent materials can be used for the planarizing layers. Specifically, examples of the constituent material include polyvinyl carbazole resin, polycarbonate resin, polyester resin, acrylonitrile butadiene styrene (ABS) resin, acrylic resin, polyimide resin, phenol resin, epoxy resin, silicone resin, and urea resin.

### Microlens

The organic light-emitting device can include an optical member such as a microlens on the light exit side thereof. The microlens can be made of, for example, acrylic resin or epoxy resin. The microlens can aim to increase the amount of light extracted from the organic light-emitting device and control the direction of light to be extracted. The microlens can have a hemispherical shape. In a case where the microlens has a hemispherical shape, among tangents contacting the hemisphere, there is a tangent parallel to the insulating layer, and the contact between the tangent and the hemisphere is the vertex of the microlens. The vertex of the microlens can be determined in a similar manner even in an optional sectional view. Thus, among tangents contacting the semicircle of the microlens in a sectional view, there is a tangent parallel to the insulating layer, and the contact between the tangent and the semicircle is the vertex of the microlens.

Moreover, the middle point of the microlens can also be defined. In the cross-section of the microlens, a line segment from a point at which an arc shape ends to a point at which another arc shape ends is assumed, and the middle point of the line segment can be called the middle point of the microlens. A cross-section for discriminating the vertex and the middle point can be a cross-section perpendicular to the insulating layer.

The microlens includes a first surface including a convex portion and a second surface opposite to the first surface. It is favorable that the second surface is arranged on a side closer to the functional layer than the first surface. In one embodiment, for attaining such a configuration, the microlens is to be formed on the organic light-emitting device. In a case where the functional layer is an organic layer, it is favorable to avoid a process which produces high temperature in the manufacturing process. Moreover, in a case where a configuration in which the second surface is arranged on a side closer to the functional layer than the first surface is employed, it is favorable that all of the glass transition temperatures of organic compounds constituting the organic layer are 100 °C (degree Celsius) or more, and it is more favorable that all of the glass transition temperatures are 130 °C or more.

### Counter Substrate

A counter substrate can be provided on the planarizing layer. The counter substrate is called a counter substrate because it is provided at a position corresponding to the above-mentioned substrate. The constituent material of the counter substrate can be the same as that of the above-mentioned substrate. In a case where the above-mentioned substrate is the first substrate, the counter substrate can be the second substrate.

### Organic Layer

The organic compound layers (for example, hole injection layer, hole transport layer, electron blocking layer, light-emitting layer, hole blocking layer, electron transport layer, and electron injection layer) constituting the organic light-emitting element is formed by a method described below.

The organic compound layers constituting the organic light-emitting element can be formed by a dry process using, for example, a vacuum deposition method, an ionization deposition method, a sputtering method, or a plasma method. Moreover, instead of the dry process, a wet process which forms a layer by dissolving a solute in an appropriate solvent and using a known coating method (for example, a spin coating method, a dipping method, a casting method, a Langmuir-Blodgett (LB) method, or an inkjet method) can be used.

Here, when the layer is formed by, for example, a vacuum deposition method or a solution coating method, for example, crystallization is unlikely to occur and an excellent temporal stability is obtained. Moreover, when the layer is formed by a coating method, it is possible to form the film in combination with a suitable binder resin.

Examples of the above-mentioned binder resin include polyvinyl carbazole resin, polycarbonate resin, polyester resin, ABS resin, acrylic resin, polyimide resin, phenol resin, epoxy resin, silicone resin, and urea resin, but the binder resin is not limited to these examples.

Moreover, one of these binder resins can be used singly as a homopolymer or a copolymer, or two or more of such binder resins can be used in a mixed manner. Additionally, additives such as a known plasticizer, antioxidant, and an ultraviolet absorber can also be used in combination as needed.

### Pixel Circuit

The organic light-emitting device can include a pixel circuit of the active matrix type, which individually performs light emission control on the first light-emitting element and the second light-emitting element. The pixel circuit of the active matrix type can be a voltage programing circuit or a current programing circuit. The organic light-emitting device includes a pixel driving circuit for every pixel.

The organic light-emitting device includes a display region and a peripheral region arranged around the display region. The organic light-emitting device includes the pixel driving circuits in the display region and includes a display control circuit, which includes the signal output circuit 300 and the signal line selector circuit 400, in the peripheral region. The mobility of a transistor included in the pixel driving circuit can be smaller than the mobility of a transistor included in the display control circuit.

The slope of the current-voltage characteristic of the transistor included in the pixel driving circuit can be smaller than the slope of the current-voltage characteristic of the transistor included in the display control circuit. The slope of the current-voltage characteristic can be measured by what is called a Vg-Ig characteristic (gate voltage-gate current characteristic).

The transistor constituting the pixel driving circuit is a transistor connected to a light-emitting element such as the first light-emitting element.

### Pixel

The organic light-emitting device includes a plurality of pixels. Each pixel includes sub-pixels which perform light emission for respective different colors. The sub-pixels can include, for example, R, G, and B emission colors, respectively.

In each pixel, a region also called a pixel opening emits light. This region is the same as the first region.

The pixel opening can have a size of greater than or equal to 5 μm and less than or equal to 15 μm. More specifically, the pixel opening can have a size of, for example, 11 μm, 9.5 μm, 7.4 μm, or 6.4 μm.

A distance between the sub-pixels can be 10 μm or less, and can be, specifically, 8 μm, 7.4 μm, or 6.4 μm.

The pixels can have a known arrangement form in a plan view. For example, the pixels may have a stripe arrangement, a delta arrangement, a pentile arrangement, or a Bayer arrangement. The shape of each sub-pixel in a plan view can be any known shape. For example, a quadrangle such as a rectangle or a rhombus or a hexagon can be employed. Naturally, these shapes do not need to be accurate shapes, and a shape close to a rectangle is included in a rectangle. The shape of the sub-pixel and the pixel arrangement can be used in combination.

### Application of Display Device

The display device according to any one of the first to fourth embodiments can be applied to a display unit of an image information processing apparatus. The image information processing apparatus can include an image input unit, which receives, as an input, image information from, for example, an area charge-coupled device (CCD) sensor, a linear CCD sensor, or a memory card, and an information processing unit, which processes the input information. Moreover, the image information processing apparatus can display the input image on the display unit.

Moreover, the display device according to any one of the first to fourth embodiments can be applied to a display unit included in an image capturing apparatus or an inkjet printer. The display unit can have a touch panel function. The driving method of the touch panel function can be an infrared type, a capacitance type, a resistive film type, or an electromagnetic induction type, and is not particularly limited. Moreover, the display device can be used for a display unit of a multifunction printer.

Next, a display device according to any one of the first to fourth embodiments is described with reference to the drawings.

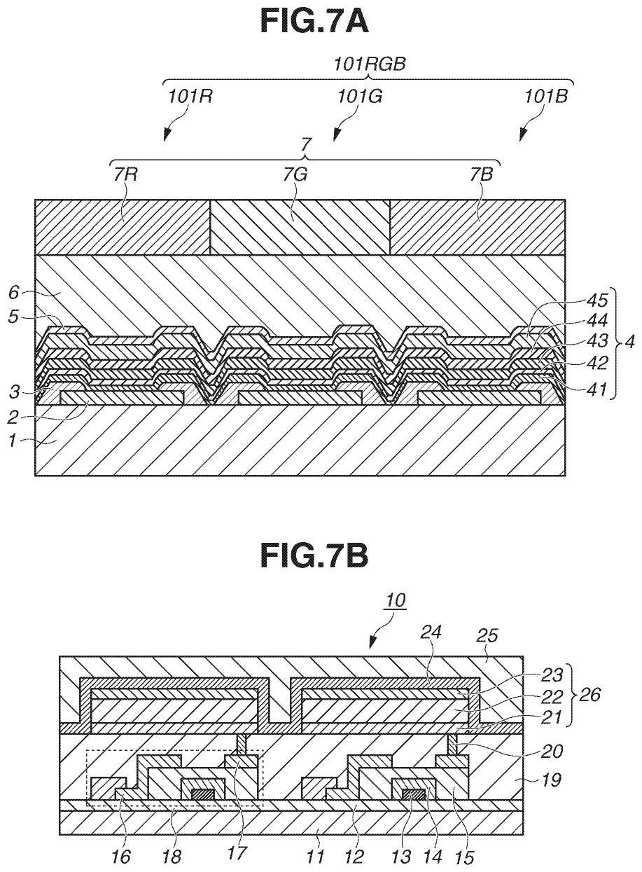

FIGS. 7A and 7B are schematic sectional views illustrating a configuration example of a part of a display device which includes a light-emitting element and a transistor connected to the light-emitting element. The transistor is an example of an active element. The transistor can be a thin-film transistor (TFT).

FIG. 7A illustrates an example of a part of a pixel which is a constituent element of the display device according to any one of the first to fourth embodiments.

The pixel includes sub-pixels 101RGB. The sub-pixels 101RGB are divided into sub-pixels 101R, 101G, and 101B depending on the respective colors of light emission. The light emission colors can be discriminated by the wavelengths of light components emitted from the light-emitting layers, or light which exits from each sub-pixel can be selectively transmitted or subjected to color conversion by, for example, a color filter.

Each sub-pixel includes, on an interlayer insulating layer 1, a reflective electrode 2, which serves as the first electrode, an insulating layer 3, which covers the end of the reflective electrode 2, an organic compound layer 4, which covers the first electrode and the insulating layer 3, a transparent electrode 5, a protection layer 6, and a color filter 7.

The interlayer insulating layer 1 can include a transistor and a capacitive element arranged in a layer under the interlayer insulating layer 1 or arranged inside the interlayer insulating layer 1.

The transistor and the first electrode can be electrically connected to each other via, for example, a contact hole (not illustrated).

The insulating layer 3 is also called a bank or a pixel isolation film. The insulating layer 3 covers the end of the first electrode, and is arranged to surround the first electrode. A portion of the first electrode where no insulating layer is arranged is in contact with the organic compound layer 4 to serve as a light-emitting area.

The organic compound layer 4 includes a hole injection layer 41, a hole transport layer 42, a first light-emitting layer 43, a second light-emitting layer 44, and an electron transport layer 45.

The second electrode 5 can be a transparent electrode, a reflective electrode, or a semi-transmissive electrode.

The protection layer 6 reduces the permeation of water into the organic compound layer 4. The protection layer 6 is illustrated as a single layer but can include a plurality of layers. Each layer can be an inorganic compound layer or an organic compound layer.

The color filter 7 is divided into color filters 7R, 7G, and 7B by the respective colors. The color filter 7 can be formed on a planarizing film (not illustrated). A resin protection layer (not illustrated) can be provided on the color filter 7. Moreover, the color filter 7 can be formed on the protection layer 6. Alternatively, the color filter 7 can be provided on the counter substrate such as a glass substrate, and then the color filter 7 and the counter substrate can be bonded to each other.

A display device 10 illustrated in FIG. 7B is provided with an organic light-emitting element 26 and a TFT 18, which is an example of a transistor. A substrate 11 made of, for example, glass or silicon is provided and an insulating layer 12 is provided on the substrate 11. An active element 18 such as a TFT is arranged on the insulating layer 12, and a gate electrode 13, a gate insulating film 14, and a semiconductor layer 15 of the active element 18 are arranged. The TFT 18 further includes the semiconductor layer 15, a drain electrode 16, and a source electrode 17. An insulating film 19 is provided above the TFT 18. The source electrode 17 and an anode 21, which constitutes the organic light-emitting element 26, are connected to each other via a contact hole 20 provided in the insulating film 19.

Furthermore, a method of electrically connecting the electrodes (anode and cathode) included in the organic light-emitting element 26 and the electrodes (source electrode and drain electrode) included in the TFT 18 to each other is not limited to that illustrated in FIG. 7B. Thus, in one embodiment, any one of the anode and cathode and any one of the TFT source electrode and drain electrode only need to be electrically connected to each other. The TFT 18 represents a thin-film transistor.

While, in the display device 10 illustrated in FIG. 7B, an organic compound layer 22 is illustrated as one layer, the organic compound layer 22 can include a plurality of layers. A first protection layer 24 and a second protection layer 25 are provided on a cathode 23 to reduce the deterioration of the organic light-emitting element 26.

While, in the display device 10 illustrated in FIG. 7B, a transistor is used as a switching element, instead of this, another switching element can be used.

Moreover, the transistor for use in the display device 10 illustrated in FIG. 7B is not limited to a transistor using a single-crystal silicon wafer, but can be a thin-film transistor including an active layer on an insulating surface of the substrate. Examples of the active layer include single-crystal silicon, amorphous silicon, non-single-crystal silicon such as microcrystalline silicon, and a non-single-crystal oxide semiconductor such as indium zinc oxide and indium gallium zinc oxide. Furthermore, a thin-film transistor is also called a TFT element.

The transistor included in the display device 10 illustrated in FIG. 7B can be formed in the substrate such as a silicon (Si) substrate. Here, forming the transistor in the substrate means forming the transistor by processing the substrate itself such as an Si substrate. Thus, the transistor being formed in the substrate can be considered as the substrate and the transistor being formed integrally with each other.

In the organic light-emitting element according to any one of the first to fourth embodiments, the light emission luminance thereof can be controlled by a TFT which is an example of a switching element, and a plurality of organic light-emitting elements can be provided in a plane to display an image with the light emission luminances of the respective organic light-emitting elements. Furthermore, the switching element according to any one of the first to fourth embodiments is not limited to a TFT, but can be a transistor formed from low-temperature polysilicon or an active matrix driver formed on the substrate such as an Si substrate. The term “on the substrate” can also be referred to as “in the substrate”. Whether to provide a transistor in the substrate or use a TFT is selected based on the size of the display unit, and, for example, if the size of the display unit is about 0.5 inches, it is favorable that the organic light-emitting element is provided on the Si substrate.

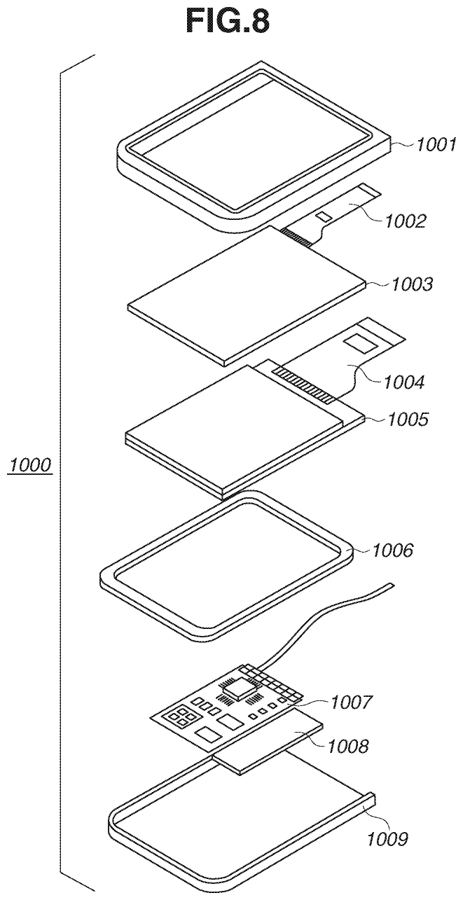

FIG. 8 is a schematic diagram illustrating an example in which the display device according to any one of the first to fourth embodiments has been applied to an electronic apparatus. The electronic apparatus 1000 can include a touch panel 1003, a display panel 1005, a frame 1006, a circuit board 1007, and a battery 1008 between an upper cover 1001 and a lower cover 1009. The display panel 1005 to be used can be the display device according to any one of the first to fourth embodiments.

Flexible printed circuit (FPC) boards 1002 and 1004 are connected to the touch panel 1003 and the display panel 1005, respectively. Transistors are printed on the circuit board 1007. The battery 1008 does not need to be provided unless the display device is portable equipment, and, even if the display device is portable equipment, the battery 1008 can be provided at another position.

The display device according to any one of the first to fourth embodiments can include color filters of red, green, and blue. The color filters of red, green, and blue can be arranged in a delta array.

The display device according to any one of the first to fourth embodiments can be used as a display unit of a portable terminal. In such case, the display unit can have both a display function and an operation function. Examples of the portable terminal include a mobile phone such as a smartphone, a tablet, and a head-mounted display.

The display device according to any one of the first to fourth embodiments can be used for a display unit of an image capturing apparatus including an optical unit having a plurality of lenses and an image sensor for receiving light having passed through the optical unit. The image capturing apparatus can include a display unit for displaying information acquired by the image sensor. In addition, the display unit can be either a display unit exposed outside the image capturing apparatus, or a display unit arranged inside a viewfinder. The image capturing apparatus can be a digital camera or a digital video camera.

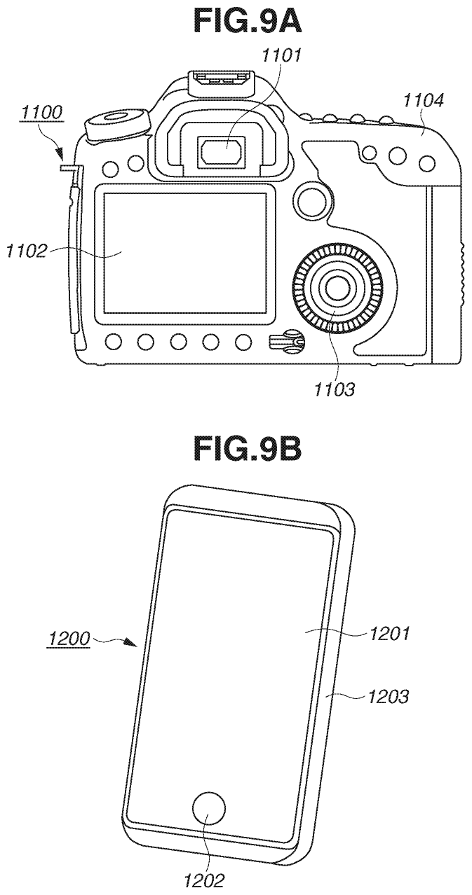

FIG. 9A is a schematic diagram illustrating an example of an image capturing apparatus according to any one of the first to fourth embodiments. The image capturing apparatus 1100 can include a viewfinder 1101, a rear display 1102, an operation unit 1103, and a housing 1104. The viewfinder 1101 can include a display device according to any one of the first to fourth embodiments. In this case, the display device can display not only an image to be captured but also, for example, environment information or image capturing instructions. Examples of the environment information can include, for example, the intensity of external light, the direction of external light, the movement speed of a subject, and the possibility that a subject is occluded by an obstacle.

The timing suitable for image capturing is a very short time, so that it is favorable that the information is displayed as soon as possible. Accordingly, it is favorable to use a display device according to any one of the first to fourth embodiments including an organic light-emitting element as a light-emitting element. This is because the display device according to any one of the first to fourth embodiments is capable of performing writing of a signal with ringing thereof prevented or reduced in a limited time. Moreover, since the organic light-emitting element is high in response speed, using the organic light-emitting element as a light-emitting element enables increasing the display speed. The display device according to any one of the first to fourth embodiments can be used more suitably for such apparatuses requiring a high display speed than a liquid crystal display device.

The image capturing apparatus 1100 includes an optical unit (not illustrated). The optical unit has a plurality of lenses, and forms an image on an image sensor contained in the housing 1104. The focus of the plurality of lenses can be adjusted by adjusting the relative positions thereof. This operation can also be automatically performed. The image capturing apparatus can be called a photoelectric conversion apparatus. The photoelectric conversion apparatus can include, as an image capturing method, not only a method of sequentially capturing images but also, for example, a method of detecting the difference from a preceding image and a method of clipping an image from a constantly recorded image.

FIG. 9B is a schematic diagram illustrating an example of an electronic apparatus according to any one of the first to fourth embodiments. The electronic apparatus 1200 includes a display unit 1201, an operation unit 1202, and a housing 1203. The housing 1203 can contain a circuit, a printed board having the circuit mounted therein, a battery, and a communication unit. The operation unit 1202 can be a button or a touch-panel-type reaction unit. The operation unit 1202 can also be a biometric recognition unit which performs, for example, unlocking by recognizing the use's fingerprint. The electronic apparatus including the communication unit can also be regarded as a communication apparatus. The electronic apparatus can also have a camera function by including a lens and an image sensor. An image captured by the camera function is displayed on the display unit 1201. Examples of the electronic apparatus include a smartphone and a laptop personal computer.

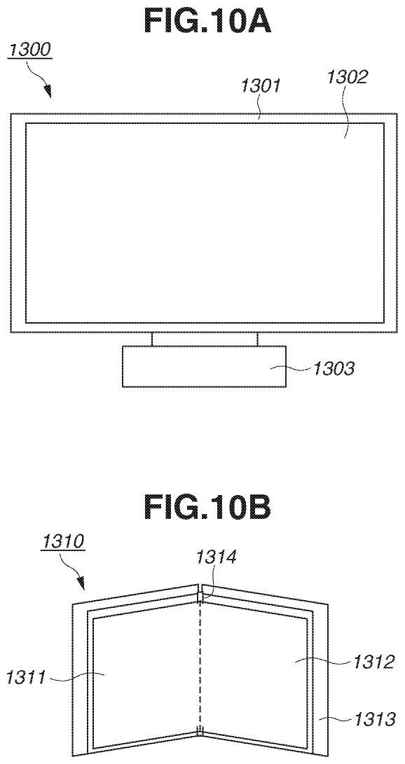

FIGS. 10A and 10B are schematic diagrams illustrating examples of a display apparatus according to any one of the first to fourth embodiments. FIG. 10A illustrates a display apparatus such as a television monitor or a personal computer (PC) monitor. The display apparatus 1300 includes a frame 1301 and a display unit 1302. The display device according to any one of the first to fourth embodiments can be used for the display unit 1302.

The display apparatus 1300 further includes a base 1303, which supports the frame 1301 and the display unit 1302. The base 1303 is not limited to the form illustrated in FIG. 10A. The lower side of the frame 1301 can also function as a base.

Moreover, the frame 1301 and the display unit 1302 can be bent. The radius of curvature in the bent portions can be greater than or equal to 5,000 millimeters (mm) and less than or equal to 6,000 mm.

FIG. 10B is a schematic diagram illustrating another example of a display apparatus according to any one of the first to fourth embodiments. The display apparatus 1310 illustrated in FIG. 10B is configured to be foldable, and is what is called a foldable display apparatus. The display apparatus 1310 includes a first display unit 1311, a second display unit 1312, a housing 1313, and a bending point 1314. Each of the first display unit 1311 and the second display unit 1312 can include the display device according to any one of the first to fourth embodiments. The first display unit 1311 and the second display unit 1312 can also be one seamless display device. The first display unit 1311 and the second display unit 1312 can be divided by the bending point 1314. The first display unit 1311 and the second display unit 1312 can display respective different images, and the first display unit 1311 and the second display unit 1312 can also display one image together.

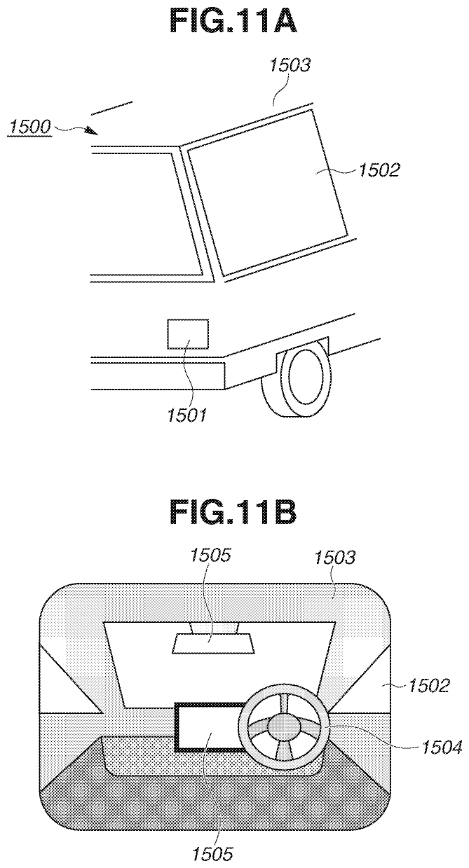

FIGS. 11A and 11B are schematic diagrams illustrating an automobile which is an example of a moving body according to any one of the first to fourth embodiments. The automobile 1500 includes a taillight which is an example of lighting equipment. The automobile 1500 has a taillight 1501, and can have a configuration in which the taillight 1501 is turned on in response to, for example, a braking operation being performed.

The taillight 1501 can include the organic light-emitting element according to any one of the first to fourth embodiments. The taillight 1501 can include a protection member for protecting an organic electroluminescence (EL) element. The material of the protection member is not limited as long as the material is a transparent material with a strength which is high to some extent, and it is favorable that the protection member is made of, for example, polycarbonate. For example, a furandicarboxylic acid derivative or an acrylonitrile derivative can be mixed in polycarbonate.

The automobile 1500 can include a vehicle body 1503 and a window 1502, which is mounted to the vehicle body 1503. Unless the window 1502 is a window for checking the front and back of the automobile 1500, the window 1502 can be a transparent display. The transparent display can include an organic light-emitting element according to any one of the first to fourth embodiments. In this case, the constituent materials of, for example, the electrodes of the organic light-emitting element are formed by transparent members.

Moreover, as illustrated in FIG. 11B, the automobile 1500 further includes, for example, a steering wheel 1504, which is used to control the movement direction of the moving body, and a display unit 1505, which displays, for example, a map, the position of the moving body, and the direction in which the moving body is turning and which is mounted to the vehicle body 1503. The display unit 1505 can include the display device according to any one of the first to fourth embodiments.

The moving body according to any one of the first to fourth embodiments includes one of or both a drive force generation unit, which generates drive force for use in movement of the moving body, and a rotating body, which is mainly for use in movement of the moving body. The drive force generation unit can be, for example, an engine or a motor. The rotating body can be, for example, tires, wheels, screws for boats and ships, or airplane propeller. Specifically, the moving body can be, for example, a bicycle, an automobile, an electric train, a boat or ship, an airplane, or a drone. The moving body can include a body frame and lighting equipment provided in the body frame or a display unit provided in the body frame. The lighting equipment can perform light emission for outputting information indicating the position of the body frame. The lighting equipment can include an organic light-emitting element according to any one of the first to fourth embodiments. Moreover, the display unit can include an organic light-emitting element according to any one of the first to fourth embodiments.

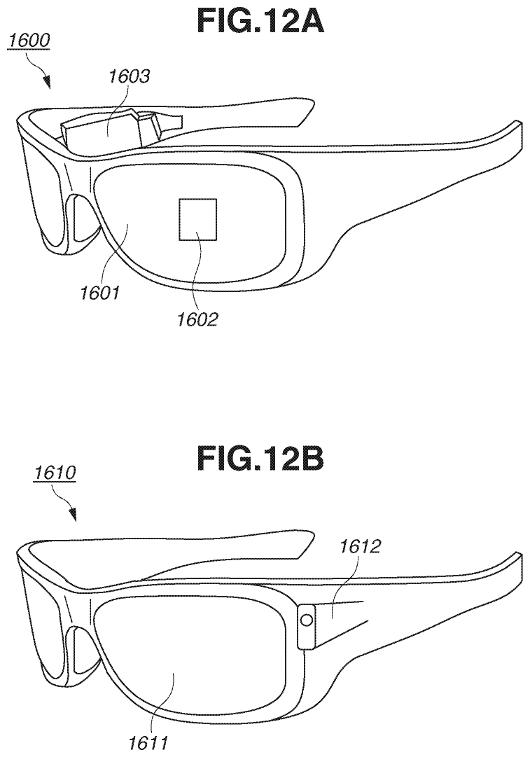

Examples of the application of a display device according to any one of the first to fourth embodiments are described with reference to FIGS. 12A and 12B. The display device can be applied to a system which is wearable as a wearable device such as smart glasses, a head-mounted display (HMD), or a smart contact lens. An image capturing display device which is used for such an application example includes an image capturing device which is capable of photoelectrically converting visible light and a display device which is capable of emitting visible light.

FIG. 12A illustrates eyeglasses 1600 (smart glasses) according to one application example. On the front surface side of a lens 1601 of the eyeglasses 1600, an image capturing device 1602 such as a complementary metal-oxide semiconductor (CMOS) sensor or a single photon avalanche diode (SPAD) sensor is provided. Moreover, on the rear surface side of the lens 1601, a display device according to any one of the first to fourth embodiments is provided.

The eyeglasses 1600 further include a control device 1603. The control device 1603 functions as a power source which supplies electric power to the image capturing device 1602 and the display device according to any one of the first to fourth embodiments. Moreover, the control device 1603 controls operations of the image capturing device 1602 and the display device. The lens 1601 includes an optical system formed therein to focus light onto the image capturing device 1602.

FIG. 12B illustrates eyeglasses 1610 (smart glasses) as an example of an electronic apparatus including a display device according to any one of the first to fourth embodiments. The eyeglasses 1610 correspond to an example of a wearable device. The eyeglasses 1610 include a control device 1612. The control device 1612 includes, mounted therein, an image capturing device, which is equivalent to the image capturing device 1602, and a display device. A lens 1611 includes an optical system formed therein to project light emitted by the display device included in the control device 1612, so that an image is projected onto the lens 1611. The control device 1612 functions as a power source which supplies electric power to the image capturing device and the display device, and controls operations of the image capturing device and the display device.

The control device 1612 can include a line-of-sight detection unit, which detects the line of sight of a person wearing the eyeglasses 1610 (user). Detection of a line of sight can be performed with use of infrared (infrared light). An infrared emission unit emits infrared light to the eyeball of a user who gazes at a displayed image. Reflected light from the eyeball out of the emitted infrared light is detected by an image capturing unit including a light receiving element, so that a captured image of the eyeball is obtained. A reducing unit for reducing light traveling from the infrared emission unit to the display unit in planar view is provided, so that a decrease in the quality of an image is reduced.

A line of sight of the user on the displayed image is detected based on a captured image of the eyeball obtained by image capturing of infrared light. An optional known method can be used for line-of-sight detection using a captured image of the eyeball. For example, a line-of-sight detection method that is based on a Purkinje image formed by reflection of radiated light on the cornea can be used.

More specifically, line-of-sight detection processing that is based on a pupil and cornea reflection method is performed. A line-of-sight vector representing the orientation (rotational angle) of the eyeball is calculated with use of the pupil and cornea reflection method based on an image of the pupil and a Purkinje image included in the captured image of the eyeball, so that a line of sight of the user is detected.

The electronic apparatus according to any one of the first to fourth embodiments can include an image capturing device including a light receiving element, and a displayed image on the display device can be controlled based on line-of-sight information about the user input from the image capturing device.

Specifically, in the display device, a first display region, at which the user gazes, and a second display region, which is other than the first display region, are determined based on the line-of-sight information. The first display region and the second display region can be determined by a control device for the display device or can be the ones determined by and received from an external control device. In a display region of the display device, the display resolution of the first display region can be controlled to be higher than the display resolution of the second display region. Thus, the display resolution of the second display region can be set lower than the display resolution of the first display region.

Moreover, the display region can include a first display region and a second display region different from the first display region, and a region higher in priority can be determined out of the first display region and the second display region based on the line-of-sight information. The first display region and the second display region can be determined by a control device for the display device or can be the ones determined by and received from an external control device. The resolution of a region higher in priority can be controlled to be higher than the resolution of a region other than the region higher in priority. Thus, the resolution of a region relatively low in priority can be set low.

Furthermore, determination of the first display region or the region higher in priority can be performed with use of artificial intelligence (AI). AI can be a model configured to set an image of the eyeball and a direction at which the eyeball in the image actually looks as training data and estimate the angle of a line of sight and a distance to an object pointed by the line of sight based on the image of the eyeball. An AI program can be included in a display device, can be included in an image capturing device, or can be included in an external device. In a case where the AI program is included in the external device, the AI program is transmitted to the display device via communication.

In the case of performing display control based on line-of-sight detection, any one of the first to fourth embodiments can be favorably applied to smart glasses including an image capturing device which performs image capturing of an outside. The smart glasses are able to display captured external information in real time.

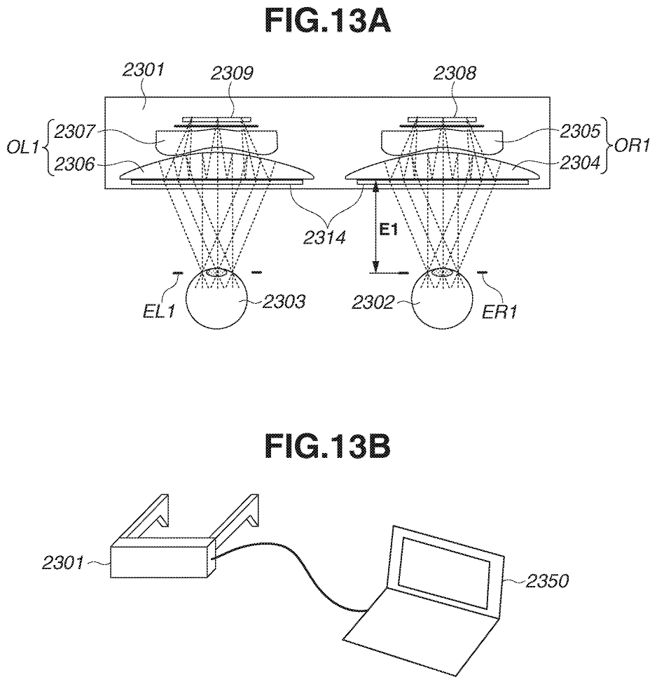

FIGS. 13A and 13B illustrate a wearable device serving as an example of an electronic apparatus including a display device according to any one of the first to fourth embodiments. Specifically, FIGS. 13A and 13B are schematic diagrams of a head-mounted display (HMD) 2301. FIG. 13A is a schematic diagram illustrating a head-mounted display and an observer who wears the head-mounted display. The HMD 2301 is worn on the head of the observer. The right eye 2302 and left eye 2303 of the observer are illustrated. Display lenses 2304 and 2305 constitute a right-eye eyepiece optical system OR1, and display lenses 2306 and 2307 constitute a left-eye eyepiece optical system OL1. Each eyepiece optical system is a coaxial optical system composed of a plurality of (two) display lenses. The right eye 2302 of the observer is arranged at the exit pupil ER1 of the right-eye eyepiece optical system OR1, and the left eye 2303 of the observer is arranged at the exit pupil EL1 of the left-eye eyepiece optical system OL1. The exit pupil ER1 is provided at a position away from the right-eye eyepiece optical system OR1 by a distance E1. Similarly, the exit pupil EL1 is provided at a position away from the left-eye eyepiece optical system OL1 by the distance E1. An optical film 2314 for, for example, lens protection or light collection is provided at each of the front surface (surface facing the right eye 2302) of the right-eye eyepiece optical system OR1 and the front surface (surface facing the left eye 2303) of the left-eye eyepiece optical system OL1.

A right-eye display device 2308 and a left-eye display device 2309 are illustrated. Each of the right-eye display device 2308 and the left-eye display device 2309 can be a display device according to any one of the first to fourth embodiments. FIG. 13B is a schematic diagram illustrating an example in which a wearable device according to any one of the first to fourth embodiments is connected to an external device, and illustrates the outer appearances of the HMD 2301 and a personal computer 2350, which is connected to the HMD 2301. The right-eye display device 2308 and the left-eye display device 2309 display images for display (original images) corresponding to image signals output from the personal computer 2350. While, in this configuration, wired connection is employed, wireless connection can be employed. Moreover, the HMD 2301 can include an image processing device mounted therein and thus can be a device which operates in stand-alone mode.

The eyepiece optical systems OR1 and OL1 guide light fluxes output from the display devices 2308 and 2309 to the exit pupils ER1 and EL1 and thus project enlarged virtual images of images for display onto the right eye 2302 and left eye 2303 of the observer, respectively. This enables the observer to observe images for display (virtual images thereof) displayed on the display devices 2308 and 2309 through the eyepiece optical systems OR1 and OL1.

Although not illustrated, the HMD 2301 can include a control device. The control device not only functions as a power source for supplying electric power to the display devices 2308 and 2309 but also controls operations of the display devices 2308 and 2309.

According to an aspect of the disclosure, it is possible to prevent or reduce ringing occurring at the time of writing of the luminance signal voltage and thus reduce the deterioration of the display quality.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-071447 filed Apr. 23, 2025, which is hereby incorporated by reference herein in its entirety.

What is claimed is:

1. A device comprising:
a pixel array in which a plurality of pixels each including a light-emitting element and a pixel driving circuit which drives the light-emitting element is arranged in matrix form;
a first signal line connected to pixels arranged in a first column of the pixel array;
a second signal line connected to pixels arranged in a second column, different from the first column, of the pixel array;
a signal output circuit electrically connected to a first node;
a first wiring connected to the signal output circuit via the first node;
a second wiring connected to the signal output circuit via the first node;
a first resistive element and a first switch connected to each other in series between the first wiring and the first signal line; and
a second resistive element and a second switch connected to each other in series between the second wiring and the second signal line.

2. The device according to claim 1,
wherein the signal output circuit is configured to output a pixel signal in a first period and output a reference signal in a second period different from the first period, and
wherein the reference signal is written to the first signal line and the second signal line when both the first switch and the second switch are in an on-state.

3. The device according to claim 1,
wherein the signal output circuit is configured to output a pixel signal in a first period and output a reference signal in a second period different from the first period, and
wherein the pixel signal is written to the first signal line when the first switch is in an on-state and the second switch is in an off-state.

4. The device according to claim 1,
wherein the signal output circuit is configured to output a pixel signal in a first period and output a reference signal in a second period different from the first period,
wherein the reference signal is written to the first signal line and the second signal line when both the first switch and the second switch are in an on-state, and
wherein the pixel signal is written to the first signal line when the first switch is in an on-state and the second switch is in an off-state.

5. The device according to claim 1, wherein each of the first resistive element and the second resistive element is a resistive element made from polysilicon or a resistive element using a diffused resistor.

6. The device according to claim 1, further comprising:
a third signal line connected to pixels arranged in a third column, different from the first column and the second column, of the pixel array; and
a fourth signal line connected to pixels arranged in a fourth column, different from the first to third columns, of the pixel array,
wherein the first resistive element is arranged between the first wiring and the third signal line, and
wherein the second resistive element is arranged between the second wiring and the fourth signal line.

7. The device according to claim 1, further comprising:
a third signal line connected to pixels arranged in a third column, different from the first column and the second column, of the pixel array; and
a fourth signal line connected to pixels arranged in a fourth column, different from the first to third columns, of the pixel array,
wherein the first resistive element is arranged between the first wiring and the third signal line,
wherein the second resistive element is arranged between the second wiring and the fourth signal line,
wherein a third switch is arranged between the first resistive element and the third signal line,
wherein a fourth switch is arranged between the second resistive element and the fourth signal line,
wherein the first switch, the third switch, and the first resistive element are connected to a second node, and
wherein the second switch, the fourth switch, and the second resistive element are connected to a third node.

8. The device according to claim 1, further comprising:
a third signal line connected to pixels arranged in a third column, different from the first column and the second column, of the pixel array; and
a fourth signal line connected to pixels arranged in a fourth column, different from the first to third columns, of the pixel array,
wherein the first resistive element is arranged between the first wiring and the third signal line,
wherein the second resistive element is arranged between the second wiring and the fourth signal line,
wherein a third switch is arranged between the first resistive element and the third signal line,
wherein a fourth switch is arranged between the second resistive element and the fourth signal line,
wherein the first switch, the third switch, and the first resistive element are connected to a second node,
wherein the second switch, the fourth switch, and the second resistive element are connected to a third node,
wherein the first resistive element is arranged between the signal output circuit and the second node, and
wherein the second resistive element is arranged between the signal output circuit and the third node.

9. The device according to claim 1, wherein, in the pixel array, the first column and the second column are adjacent to each other.

10. The device according to claim 1, further comprising:
a fifth signal line connected to pixels arranged in a fifth column, different from the first column and the second column, of the pixel array; and
a sixth signal line connected to pixels arranged in a sixth column, different from the first column, the second column, and the fifth column, of the pixel array,
wherein the fifth signal line is connected to the signal output circuit via a fourth node,
wherein the sixth signal line is connected to the signal output circuit via the fourth node,
wherein, between the fourth node and the fifth signal line, a fifth switch is arranged and no resistive element is arranged, and
wherein, between the fourth node and the sixth signal line, a sixth switch is arranged and no resistive element is arranged.

11. The device according to claim 10, wherein, between the fifth column and the sixth column, a column different from the first column and the second column is arranged.

12. The device according to claim 10, wherein a color of light which the pixels arranged in the fifth column emit and a color of light which the pixels arranged in the sixth column emit are identical.

13. The device according to claim 10, wherein, in the pixel array, distances of the first column and the second column from an end in a row direction of the pixel array are larger than distances of the fifth column and the sixth column from the end of the pixel array.

14. A conversion apparatus comprising:
an optical unit including a plurality of lenses;
an image sensor configured to receive light having passed through the optical unit; and
a display unit configured to display an image,
wherein the display unit includes the device according to claim 1.

15. An apparatus comprising:
a housing provided with a display unit; and
a communication unit provided in the housing and configured to communicate with an external unit,
wherein the display unit includes the device according to claim 1.

16. The apparatus according to claim 15, wherein the device further comprises:
a third signal line connected to pixels arranged in a third column; and
a fourth signal line connected to pixels arranged in a fourth column,
wherein the first resistive element is arranged between the first wiring and the third signal line, and
wherein the second resistive element is arranged between the second wiring and the fourth signal line.

17. A wearable device comprising:
a lens; and
the device according to claim 1 provided at the lens.

18. The wearable device according to claim 17, wherein the device further comprises:
a third signal line connected to pixels arranged in a third column; and
a fourth signal line connected to pixels arranged in a fourth column,
wherein the first resistive element is arranged between the first wiring and the third signal line, and
wherein the second resistive element is arranged between the second wiring and the fourth signal line.

19. A moving body comprising:
a display unit including the device according to claim 1; and
a body frame in which the display unit is provided.
